(19) United States
(12) Patent Application Publication
(10) Pub. No.: US 2012/0032437 A1
(43) Pub. Date: Feb. 9, 2012

(54) HOSE REEL SWIVEL

(76) Inventors: Bradley H. Hines, Andover, MN (US); Barry W. Mattson, Elk River, MN (US); Steven D. Becker, Blaine, MN (US)

(21) Appl. No.: 13/264,472

(22) PCT Filed: Apr. 16, 2010
(86) PCT No.: PCT/US10/31390

§ 371 Date: Oct. 14, 2011

Related U.S. Application Data
(60) Provisional application No. 61/169,994, filed on Apr. 16, 2009.

(51) Int. Cl. F16L 27/00

(52) U.S. Cl. 285/275

(57) ABSTRACT

A hose reel swivel (10), comprising a shaft (20) having a fluid passage therein, a swivel housing (22) rotatable about said shaft (20) and a plurality of UHMWPE with fluorocarbon o-ring energized seals (24) located between said shaft (20) and said swivel housing (22). The hose reel swivel (10) allows the user to coil a hose (12) with a reel (14) and store on a paint sprayer (16). This eliminates having to coil a hose by hand, which reduces the time to coil the hose, eliminates hose kinks and stores a coiled hose more compactly and securely. The swivel design provides longer life.

### TECHNICAL FIELD

This application claims the benefit of U.S. application Ser. No. 61/169,994, filed Apr. 16, 2009, the contents of which are hereby incorporated by reference.

### BACKGROUND ART

Existing swivels use o-rings or a stack of multiple leather v-packings.

### DISCLOSURE OF THE INVENTION

The swivel consists of the following: (1) a hardened stainless steel shaft that fluid flows through and the swivel housing rotates around; (2) a carbon steel with zinc plated swivel housing contains the seals and an outlet fitting; (3) a UHMWPE with fluorocarbon o-ring energized seals; (4) threaded brass retainers support the seals and provide a bushing against the shaft; and (5) a retaining clip on end of the shaft.

The hose reel swivel uses o-ring energized UHMWPE seals that last longer than prior art o-ring swivels. It also has larger flow passages for high viscosity fluids. It also has less parts than V-packing swivels.

These and other objects and advantages of the invention will appear more fully from the following description made in conjunction with the accompanying drawings wherein like reference characters refer to the same or similar parts throughout the several views.

### BRIEF DESCRIPTION OF DRAWINGS

FIG. 1 shows a cross-section of the swivel.

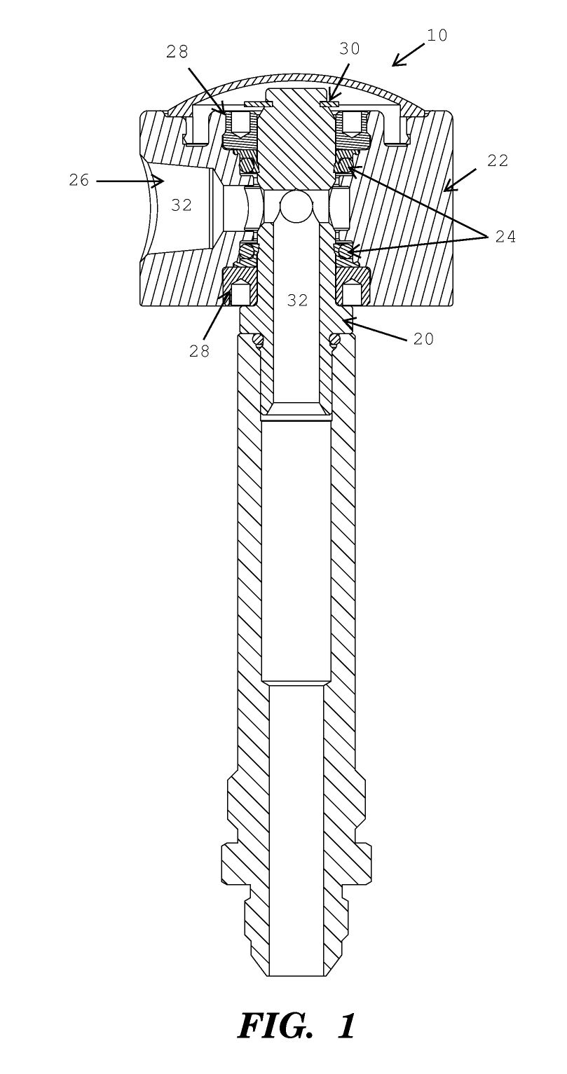

FIG. 2 shows an isometric cross-section of the swivel in relation to the hose reel.

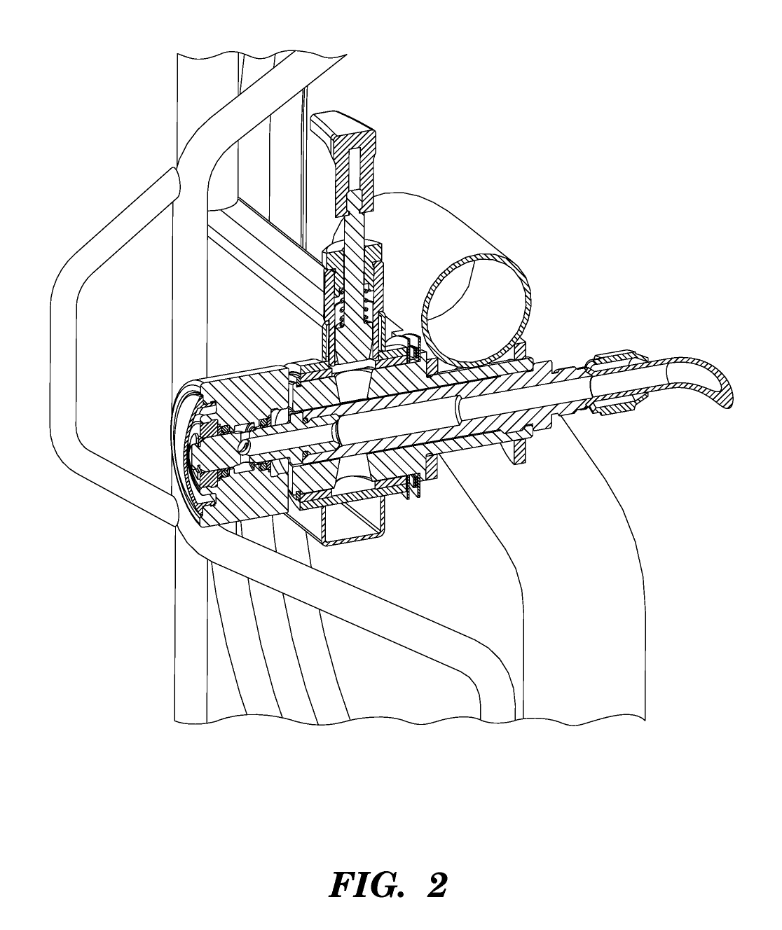

FIG. 3 shows the hose reel and swivel in relation to a paint sprayer.

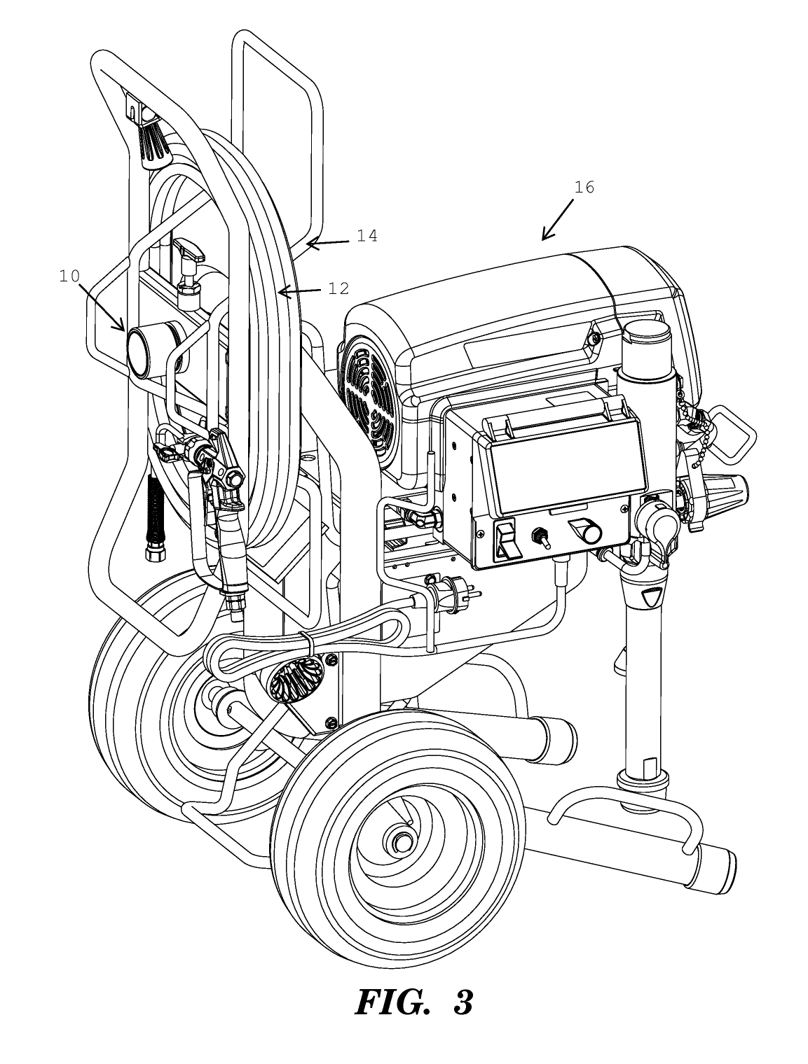

### BEST MODE FOR CARRYING OUT THE INVENTION

The hose reel swivel 10 allows the user to coil a hose 12 with a reel 14 and store on a paint sprayer 16. This eliminates having to coil a hose 12 by hand, which reduces the time to coil the hose 12, eliminates hose kinks and stores a coiled hose more compactly and securely.

The swivel 10 consists of the following: (1) a hardened stainless steel shaft 20 that fluid flows through and the swivel housing 22 rotates around; (2) a carbon steel with zinc plated swivel housing 22 contains the seals 24 and an outlet fitting 26; (3) a UHMWPE with fluorocarbon o-ring energized seals 24; (4) threaded brass retainers 28 support the seals 24 and provide a bushing against the shaft 20; and (5) a retaining clip 30 on end of the shaft 20.

The hose reel swivel 18 uses o-ring energized ultra high molecular weight polyethylene (UHMWPE) seals 24 that last longer than prior art o-ring swivels. It also has larger flow passages 32 for high viscosity fluids. It also has less parts than V-packing swivels.

It is contemplated that various changes and modifications may be made to the swivel without departing from the spirit and scope of the invention as defined by the following claims.

1. A fluid swivel comprising:
a shaft having fluid passages therein;
a swivel housing rotatable about said shaft;
a plurality of UHMWPE with fluorocarbon o-ring energized seals located between said shaft and said swivel housing;
an outlet fitting; and
a plurality of retainers supporting said seals and providing a bushing against said shaft.

2. The swivel of claim 1 wherein said fluid passages are sized to flow high viscosity fluids.
